(19) United States
(12) Patent Application Publication
(10) Pub. No.: US 2022/0410414 A1
(43) Pub. Date: Dec. 29, 2022

(54) INGENIOUS FOLDING KNIFE UNLOCKED WITH BUTTON

(71) Applicant: Shenzhen OutTech Technology Co., LTD, Shenzhen (CN)

(72) Inventor: Yue Dong, Shanghai (CN)

(73) Assignee: Shenzhen OutTech Technology Co., LTD, Shenzhen (CN)

(21) Appl. No.: 17/898,504

(22) Filed: Aug. 30, 2022

(51) Int. Cl. B26B 1/04; B26B 1/10

(52) U.S. Cl. CPC B26B 1/046; B26B 1/10

(57) ABSTRACT

An ingenious folding knife unblocked with a button is provided, including a knife handle and a blade; the knife handle is provided with an accommodating slot; the blade is mounted in the accommodating slot; the blade is provided with a rotating through slot; the rotating through slot is provided with a first positioning slot and a second positioning slot; a shaft lock piece is arranged on the knife handle; the shaft lock piece is provided with a first pillar body; the first pillar body is connected with a spring; and the first pillar body is selectively positioned in the first positioning slot and the second positioning slot. The folding knife has an ingenious overall design, works stably and reliably, and is folded and unfolded smoothly.

### TECHNICAL FIELD

The present disclosure relates to the field of folding knives, in particular to an ingenious folding knife unlocked with a button.

### BACKGROUND

The statements here only provide the background information related to the present disclosure, and do not necessarily constitute the prior art.

In daily life, a folding knife is a commonly used tool. A folding knife generally includes a knife handle and a blade, and the blade can be unfolded and folded relative to the knife handle. However, the existing folding knife is usually folded or unfolded with hands due to its unreasonable structural design, so that the operation is relatively cumbersome and wastes time and labor. Furthermore, the service life of the existing folding knife needs to be prolonged, and the production convenience needs to be improved.

Therefore, it is necessary to study a new technical solution to solve the above problems.

### SUMMARY

In order to solve the defects and shortcomings in the prior art, the present disclosure provides an ingenious folding knife unlocked with a button. By designing a novel ingenious tool which is convenient to fold and unfold, so that a user can fold and unfold the folding knife with a single hand; and at the same time, the folding knife has an ingenious clever overall design, works stably and reliably, and is folded and unfolded smoothly.

In order to achieve the above-mentioned purpose, the present disclosure adopts the following technical solution: an ingenious folding knife unblocked with a button includes a knife handle and a blade; the knife handle is provided with an accommodating slot; the blade is mounted in the accommodating slot in a rotatably foldable manner; a rear side of the blade is provided with a “C”-shaped rotating through slot; a first positioning slot and a second positioning slot are further formed in the rotating through slot; a rotating center is further arranged on an inner side of the rotating through slot; the rotating center is provided with a rotating shaft connected to the knife handle;

a shaft lock piece is further arranged at a position, corresponding to the rotating through slot, on the knife handle; the shaft lock piece transversely runs through the rotating through slot; furthermore, the shaft lock piece is provided with a second pillar body, a first pillar body connected to one end of the second pillar body, and a button piece connected to the other end of the second pillar body; a diameter of the first pillar body is greater than that of the second pillar body;

the first pillar body is connected with a spring, and is arranged on a slot wall of the accommodating slot in a left-right movable manner through the spring; and the first pillar body is selectively positioned in the first positioning slot and the second positioning slot.

As a preferable solution, the knife handle is provided with a stop nail corresponding to the rotating through slot; and the stop nail is in contact with one end portion of the rotating through slot for limitation when the blade completely spreads.

As a preferable solution, the stop nail, the rotating shaft and the shaft lock piece are all made of 416 stainless steel; and the spring is made of a piano wire.

As a preferable solution, an outer side surface of the first pillar body is provided with an inner mounting hole in a manner of being sunken towards the inner side; and the spring is mounted in the inner mounting hole.

As a preferable solution, the blade is made of S35VN steel.

As a preferable solution, the knife handle includes a first handle and a second handle which are disposed at an interval; the first handle and the second handle are assembled and connected to form the accommodating slot; and

friction grooves used for increasing gripping force are formed in outer side surfaces of the first handle and the second handle.

As a preferable solution, a holding clip is mounted and connected to the first handle or the second handle.

As a preferable solution, each of the first handle and the second handle includes an inner covering piece and an outer covering piece; an inner side surface of the outer covering piece has a mounting recess for mounting the inner covering piece; and the inner covering piece is mounted in the mounting recess.

As a preferable solution, the inner covering piece is made of a 3CR13 material.

As a preferable solution, the outer covering piece is made of a composite material synthesized by glass fiber and resin.

Compared with the prior art, the present disclosure has obvious advantages and beneficial effects. Specifically, it can be known from the above technical solutions, mainly by designing a novel ingenious tool which is convenient to fold and unfold, so that a user can fold and unfold the folding knife with a single hand; and at the same time, the folding knife has an ingenious overall design, works stably and reliably, and is folded and unfolded smoothly.

Furthermore, by material selection and design of specific parts, the practicability and the durability of the knife of the present application are further improved, and the service life of the knife is prolonged.

In order to describe the structural features and effects of the present disclosure more clearly, the present disclosure is described in detail below in combination with the accompanying drawings and specific embodiments.

### BRIEF DESCRIPTION OF THE DRAWINGS

FIG. 1 is a schematic three-dimensional diagram of an embodiment of the present disclosure;

FIG. 2 is a schematic three-dimensional diagram of an embodiment of the present disclosure in another angle;

FIG. 3 is an exploded diagram of an embodiment of the present disclosure;

FIG. 4 is a partially enlarged diagram of FIG. 3.

FIG. 5 is a schematic sectional diagram of an embodiment of the present disclosure;

FIG. 6 is a schematic diagram of an unfolding principle of an embodiment of the present disclosure;

FIG. 7 is a schematic diagram of a folding principle of the embodiment of the present disclosure.

### REFERENCE SIGNS IN THE DRAWINGS

10: knife handle; 101: first handle; 102: second handle; 103: inner covering piece; 1031: through hole; 104: outer covering piece; 1041: mounting recess; 11: accommodating slot; 12: stop nail; 13: friction groove; 14: holding clip; 15: finger recess; 20: blade; 21: rotating through slot; 211: first positioning slot; 212: second positioning slot; 22: rotating shaft; 23: bearing retainer; 24: tooth; 25: through slot; 30: shaft lock piece; 31: first pillar body; 311: inner mounting hole; 32: second pillar body; 33: button piece; and 34: spring.

### DETAILED DESCRIPTION OF THE EMBODIMENTS

The technical solutions in the embodiments of the present disclosure will be clearly and completely described below in conjunction with the accompanying drawings. Apparently, the described embodiments are only preferred embodiments of the present disclosure.

It should be noted that when an element is referred to as being “fixed” to another element, it can be directly on the other element or an intermediate element may also exist. When an element is considered to be “connected” to another element, it can be directly connected to the other element or an intermediate element may be present at the same time. The terms “perpendicular”, “horizontal”, “left”, “right” and similar expressions used herein are for illustrative purposes only, and are not meant to be the only implementation modes.

Unless otherwise defined, all technical and scientific terms used herein are the same as meanings of general understandings of those skilled in the art of the present disclosure. The terms used in the description of the present disclosure herein are merely to describe the specific implementation modes, not intended to limit the present disclosure. The term “and/or” used herein includes any and all combinations of one or more related listed items.

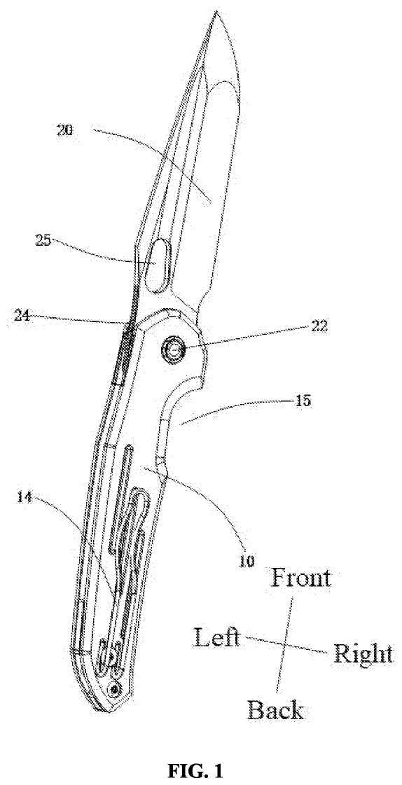

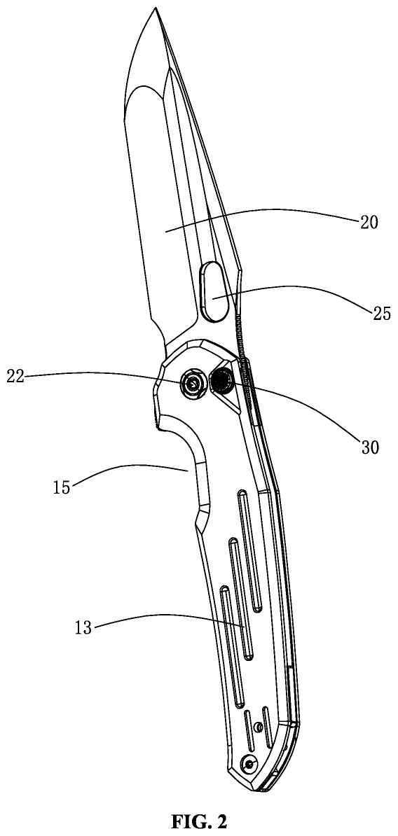

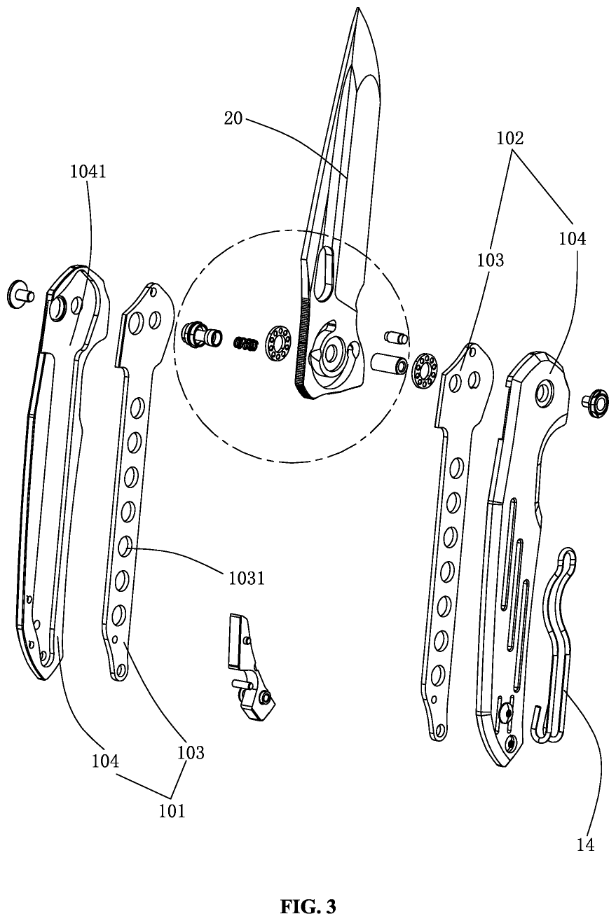

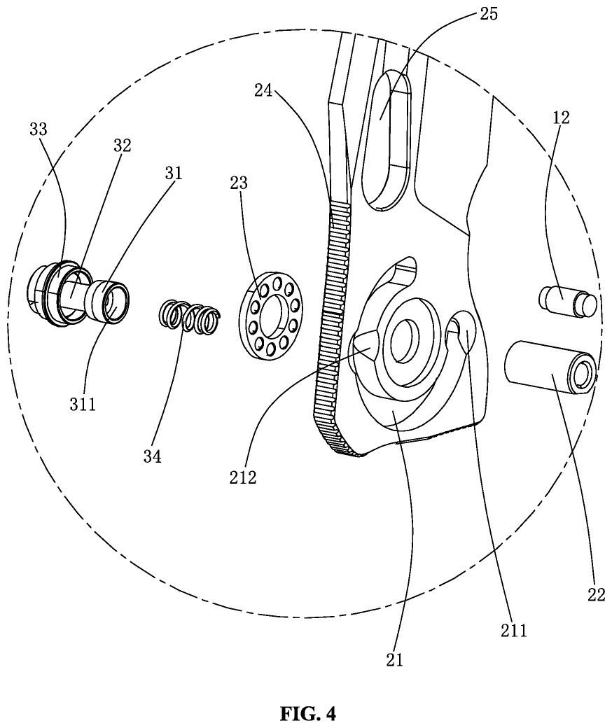

Referring to FIG. 1 to FIG. 7, an ingenious folding knife unblocked with a button in an embodiment of the present disclosure includes a knife handle 10 and a blade 20; the knife handle 10 is provided with an accommodating slot 11; the blade 20 is mounted in the accommodating slot 11 in a rotatably foldable manner; a rear side of the blade 20 is provided with a “C”-shaped rotating through slot 21; a first positioning slot 211 and a second positioning slot 212 are further formed in the rotating through slot 21; a rotating center is further arranged on an inner side of the rotating through slot 21; the rotating center is provided with a rotating shaft 22 connected to the knife handle 10;

a shaft lock piece 30 is further arranged at a position, corresponding to the rotating through slot 21, on the knife handle 10; the shaft lock piece 30 transversely runs through the rotating through slot 21; furthermore, the shaft lock piece 30 is provided with a second pillar body 32, a first pillar body 31 connected to one end of the second pillar body 32, and a button piece 33 connected to the other end of the second pillar body 32; a diameter of the first pillar body 31 is greater than that of the second pillar body 32; furthermore, the first pillar body 31 is matched with the first positioning slot 211 and the second positioning slot 212;

the first pillar body 31 is connected with a spring 34, and is arranged on a slot wall of the accommodating slot 11 in a left-right movable manner through the spring 34; and the first pillar body 31 is selectively positioned in the first positioning slot 211 and the second positioning slot 212.

It should be noted that the size of the button piece 33 is larger than that of the second pillar body 32, thus playing a role of mounting the shaft lock piece 30 to the knife. The first positioning slot 211 is located at one end portion of the rotating through slot 21, and the second positioning slot 212 is close to the other end portion of the rotating through slot 21. Specifically, the first positioning slot 211 and the second positioning slot 212 are located near the diameter of a circle center passing through the rotating shaft 22 and are located on two sides of the circle center with the diameter.

During use, the button piece 33 is pressed, and the spring 34 is compressed under a pressure; the shaft lock piece 30 forwards (to the right) moves (the main purpose is to drive the first pillar body 31 to forwards move) until the first pillar body 31 leaves the first positioning slot 211 or the second positioning slot 212 of the rotating through slot 21, and the second pillar 32 is located in the rotating through slot 21; and at this time, the blade 20 can be rotatably folded or unfolded (to achieve unlocking).

After the blade 20 is rotatably folded or unfolded in place, the button piece 33 is released; at this time, under the force accumulation action of the spring 34, the spring 34 drives the shaft lock piece 30 to move backwards until the first pillar body 31 of the shaft lock piece 30 is located in the rotating through slot 21, and the first pillar body 31 is matched with the first positioning slot 211 or the second positioning slot 212 for positioning, thus locking the blade 20.

Further, the knife handle 10 is provided with a stop nail 12 which prevents and limits the blade 20 from spreading and corresponds to the rotating through slot 21; and the stop nail 12 is in contact with one end portion of the rotating through slot 21 for limitation when the blade 20 completely spreads.

Folding and unfolding processes of the blade 20 of this embodiment are further approximately described below:

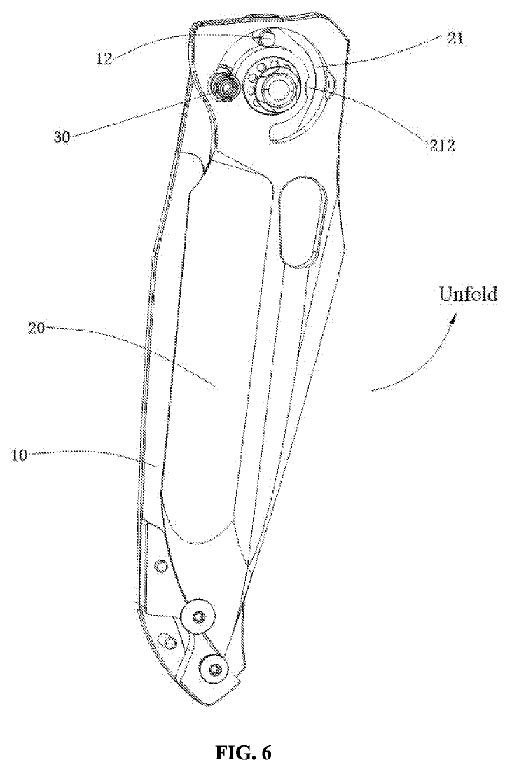

As shown in FIG. 6, in a folded state, the shaft lock piece 30 is locked in the first positioning slot 211; the button piece 33 is then pressed to achieve the above-mentioned unlocking process; at this time, the blade 20 is rotatably unfolded until one end portion of the rotating through slot 21 is in contact with the stop nail 12 (in place); the button piece 33 is then released; and at this time, the shaft lock piece 30 is locked in the second positioning slot 212 under the elasticity of the spring 34.

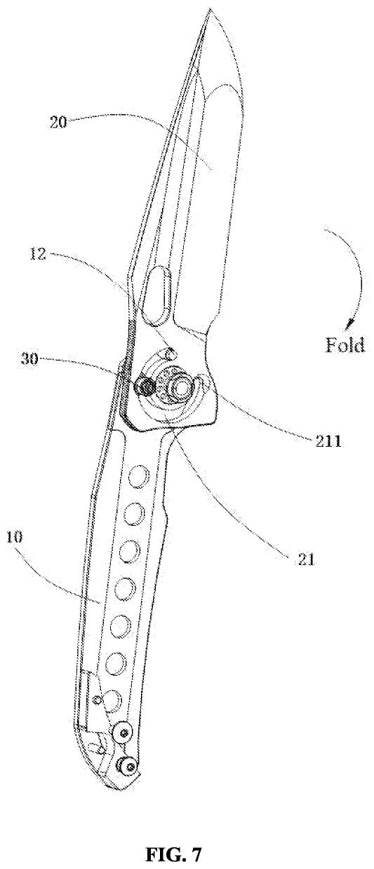

As shown in FIG. 7, in an unfolded state, the shaft lock piece 30 is locked in the second positioning slot 212; the button piece 33 is then pressed to achieve the above-mentioned locking process; at this time, the blade 20 is rotatably folded until the other end of the rotating through slot 21 is in contact with the shaft lock piece 30 (the first positioning slot 211) (in place); the button piece 33 is then released; and at this time, the shaft lock piece 30 is locked in the first positioning slot 211.

Specifically, the stop nail 12, the rotating shaft 22 and the shaft lock piece 30 are all preferably made of 416 stainless steel (martensitic grade stainless steel); and the 416 stainless steel has the advantages of good corrosion resistance, good machinability and small friction coefficient. Using this type of stainless steel is used for manufacturing the stop nail 12, the rotating shaft 22 and the shaft lock piece 30 can facilitate machining and production processes of these parts, and can also well ensure the service durability of the knife and the smoothness of folding and unfolding of the knife.

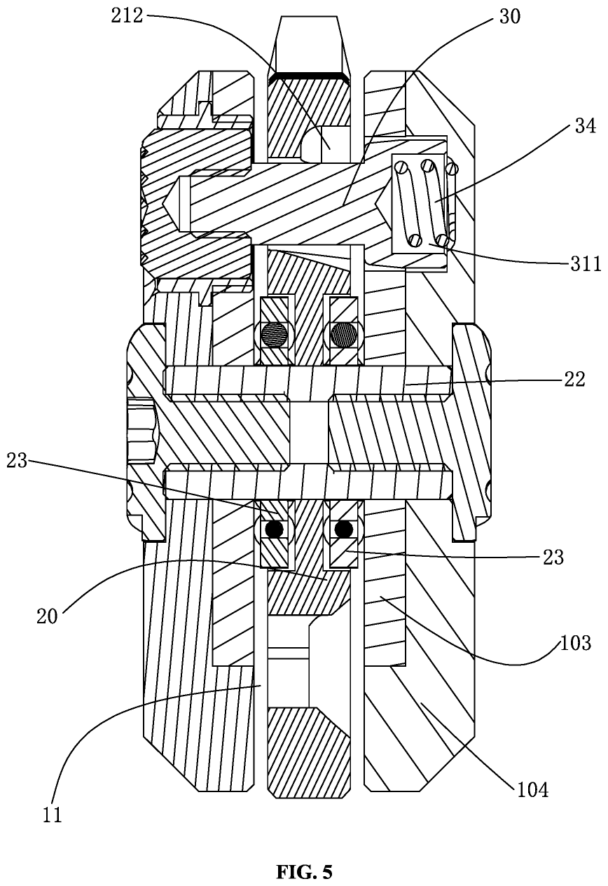

Preferably, the spring 34 is made of a piano wire. Compared with an ordinary spring 34, the spring 34 made of the piano wire has extremely good corrosion resistance, high tensile strength and excellent extensibility. Further, referring to FIG. 5, an outer side surface of the first pillar body 31 is provided with an inner mounting hole 311 in a manner of being sunken towards the inner side; and the spring 34 is mounted in the inner mounting hole 311.

Further, the blade 20 is preferably made of S35VN steel. Compared with an ordinary blade 20, the blade 20 made of S35VN steel has the advantages of good toughness, good wear resistance and high pollution resistance.

The knife handle 10 includes a first handle 101 and a second handle 102 which are disposed at an interval; the first handle 101 and the second handle 102 are assembled and connected to form the accommodating slot 11. Each of the first handle 101 and the second handle 102 includes an inner covering piece 103 and an outer covering piece 104. The inner covering piece 103 is hardware (the inner covering piece is preferably made of a 3CR13 material, which has the advantages of high abrasion resistance, corrosion resistance and machinability). The outer covering piece 104 is preferably made of a composite material synthesized by glass fiber and resin. At the same time, an inner side surface of the outer covering piece 104 has a mounting recess 1041 for mounting the inner covering piece 103; and the inner covering piece 103 is provided with several through holes 1031 along a front-back direction. In this way, the knife handle 10 has the advantages of high structural strength, difficulty in deformation, good insulation property, high anti-acid and alkali performance and light weight.

Furthermore, friction grooves 13 used for increasing gripping force are formed in outer side surfaces of the first handle 101 and the second handle 102. In this embodiment, three friction grooves 13 form one group, which are arranged on the outer side surfaces of the first handle 101 and the second handle 102. Preferably, a holding clip 14 is mounted and connected to the first handle 101 or the second handle 102. By means of the holding clip 14, a user can clamp the knife at a position such as a trousers pocket. It should be noted that the holding clip 14 is an elastic component featuring with deformation resilience.

A finger recess 15 convenient for holding is arranged on the knife handle 10.

Preferably, a bearing retainer 23 is arranged at positions, corresponding to the rotating shaft 22, of the blade 20. There are two bearing retainers 23, one of which is arranged on a right side surface of the blade 20 and the other one of which is arranged on a left side surface of the blade 20. Each bearing retainer 23 is provided with several steel balls. The several steel balls are in rolling contact between the inner covering piece 103 and the blade 20. In this way, the smoothness of folding and unfolding of the blade 20 is further improved.

Further, teeth 24 are also arranged on an upper side surface (the back of the knife) of the rear part of the blade 20, and a through slot 25 is formed in the middle rear part of the blade 20. In an unfolding operation, a user can press the button piece 33 with a finger to throw out the blade 20 (i.e. to rotate the blade 20), that is, the unfolding operation is completed with one hand. Or, the user can toggle the teeth 24 with another finger when pressing the button piece 33, so that the blade 20 rotates to be unfolded. Or, the user can toggle the through slot 25 when pressing the button piece 33 with a finger, so that the blade 20 rotates. That is, the knife of the present application further has the advantage of being suitable for single-hand operation.

According to the design key of the present disclosure, mainly by designing a novel ingenious tool which is convenient to fold and unfold, so that a user can fold and unfold the folding knife with a single hand; and at the same time, the folding knife has an ingenious overall design, works stably and reliably, and is folded and unfolded smoothly.

Furthermore, by material selection and design of specific parts, the practicability and the durability of the knife of the present application are further improved, and the service life of the knife is prolonged.

The above descriptions are only preferred embodiments of the present disclosure, and do not limit the technical scope of the present disclosure. Therefore, any minor changes, equivalent changes and modifications made to the above embodiments according to the technical essence of the present disclosure still fall within the scope of the technical solutions of the present disclosure.

What is claimed is:

1. An ingenious folding knife unblocked with a button, comprising a knife handle and a blade, wherein the knife handle is provided with an accommodating slot; the blade is mounted in the accommodating slot in a rotatably foldable manner; a rear side of the blade is provided with a “C”-shaped rotating through slot; a first positioning slot and a second positioning slot are further formed in the rotating through slot; a rotating center is further arranged on an inner side of the rotating through slot; the rotating center is provided with a rotating shaft connected to the knife handle;
a shaft lock piece is further arranged at a position, corresponding to the rotating through slot, on the knife handle; the shaft lock piece transversely runs through the rotating through slot; furthermore, the shaft lock piece is provided with a second pillar body, a first pillar body connected to one end of the second pillar body, and a button piece connected to the other end of the second pillar body; a diameter of the first pillar body is greater than that of the second pillar body;
the first pillar body is connected with a spring, and is arranged on a slot wall of the accommodating slot in a left-right movable manner through the spring; and the first pillar body is selectively positioned in the first positioning slot and the second positioning slot.

2. The ingenious folding knife unblocked with the button according to claim 1, wherein the knife handle is provided with a stop nail corresponding to the rotating through slot; and the stop nail is in contact with one end portion of the rotating through slot for limitation when the blade completely spreads.

3. The ingenious folding knife unblocked with the button according to claim 2, wherein the stop nail, the rotating shaft and the shaft lock piece are all made of 416 stainless steel; and the spring is made of a piano wire.

4. The ingenious folding knife unblocked with the button according to claim 2, wherein an outer side surface of the first pillar body is provided with an inner mounting hole in a manner of being sunken towards the inner side; and the spring is mounted in the inner mounting hole.

5. The ingenious folding knife unblocked with the button according to claim 2, wherein the blade is made of S35VN steel.

6. The ingenious folding knife unblocked with the button according to claim 1, wherein the knife handle comprises a first handle and a second handle which are disposed at an interval; the first handle and the second handle are assembled and connected to form the accommodating slot; and
friction grooves used for increasing gripping force are formed in outer side surfaces of the first handle and the second handle.

7. The ingenious folding knife unblocked with the button according to claim 6, wherein a holding clip is mounted and connected to the first handle or the second handle.

8. The ingenious folding knife unblocked with the button according to claim 6, wherein each of the first handle and the second handle comprises an inner covering piece and an outer covering piece; an inner side surface of the outer covering piece has a mounting recess for mounting the inner covering piece; and the inner covering piece is mounted in the mounting recess.

9. The ingenious folding knife unblocked with the button according to claim 8, wherein the inner covering piece is made of a 3CR13 material.

10. The ingenious folding knife unblocked with the button according to claim 8, wherein the outer covering piece is made of a composite material synthesized by glass fiber and resin.
